(19) United States
(12) Patent Application Publication
(10) Pub. No.: US 2016/0132265 A1
(43) Pub. Date: May 12, 2016

(54) STORAGE DEVICE AND OPERATING METHOD OF THE SAME

(71) Applicant: Samsung Electronics Co., Ltd., Suwon-si (KR)

(72) Inventors: JinHo YI, Suwon-si (KR); Dong-Uk KIM, Seoul (KR)

(21) Appl. No.: 14/862,089

(22) Filed: Sep. 22, 2015

(30) Foreign Application Priority Data
Nov. 10, 2014 (KR) 10-2014-0155556

(51) Int. Cl. G06F 3/06

(52) U.S. Cl. CPC G06F 3/0629; G06F 3/0604; G06F 3/0683

(57) ABSTRACT

A storage device includes a first memory, a second memory, and a memory controller. The memory controller may include a first controller configured to access the first memory according to a request of an external host device, and a second memory controller configured to access the second memory according to the request of the external host device. The first memory and first memory controller may be configured so that the first memory operates according to a first configuration type, and the second memory and second memory controller may be configured so that the second memory operates according to a second configuration type different from the first configuration type. The memory controller is configured to receive the request from the external host device and based on the request, to store write data to the first memory, and store metadata about the write data to the second memory.

### CROSS-REFERENCE TO RELATED APPLICATIONS

This US non-provisional patent application claims priority under 35 USC §119 to Korean Patent Application No. 10-2014-0155556, filed on Nov. 10, 2014 in the Korean Intellectual Property Office, the disclosure of which is incorporated by reference in its entirety herein.

### BACKGROUND

Embodiments of the present disclosure relate to semiconductor memory devices and, more particularly, to memory devices of data centers and servers.

Semiconductor memory device are memory devices implemented using semiconductors such as silicon (Si), germanium (Ge), gallium arsenide (GaAs), and indium phosphide (InP). In general, semiconductor memory devices are classified into volatile memory devices and nonvolatile memory devices.

Volatile memory devices lose their stored data when their power supplies are interrupted. Volatile memory devices include static RAM (SRAM), dynamic RAM (DRAM), synchronous DRAM (SDRAM), and the like. Nonvolatile memory devices retain their stored data even when their power supplies are interrupted. Nonvolatile memory devices include read only memory (ROM), programmable ROM (PROM), electrically programmable ROM (EPROM), electrically erasable and programmable ROM (EEPROM), flash memory, phase-change RAM (PRAM), resistive RAM (RRAM), ferroelectric RAM (FRAM), and the like.

Conventionally, a data center or a server uses a hard disk drive (HDD) as a storage device. In recent years, communication speed of a network has been improved and the number of users using a data center or a server through a network has been increasing rapidly. Therefore, access speed of the storage device of the data center or server has a great influence on the overall operating speed of a system including the data center or the server.

Many attempts have been made to improve access speed of a storage device of a data center or a server. One of the attempts is a data center or a server employing a storage device using a nonvolatile memory such as a solid-state drive (SSD). However, although access speed of an SSD is higher than that of an HDD, there are rare examples of using the SSD in a data center or server-driven environment. Therefore, reliability of the SSD is not fully verified. Moreover, a data center or a server supporting a social network service (SNS) has a much greater number of users and a much higher access frequency than another data center or another server. Accordingly, there is a need for a storage device with improved reliability and improved access speed in a data center or server environment.

### SUMMARY OF THE INVENTION

The present disclosure provides storage devices and operating methods of the same.

A storage device according to an embodiment of the inventive concept may include a first memory, a second memory, and a memory controller. The memory controller may include a first controller configured to access the first memory according to a request of an external host device, and a second memory controller configured to access the second memory according to the request of the external host device. The first memory and first memory controller may be configured so that the first memory operates according to a first configuration type, and the second memory and second memory controller may be configured so that the second memory operates according to a second configuration type different from the first configuration type. The memory controller is configured to receive the request from the external host device and based on the request, to store write data to the first memory, and store metadata about the write data to the second memory.

In example embodiments, a storage space of the first memory may be identified as a storage space of the storage device by the external host device, and a storage space of the second memory may not be identified as the storage space of the storage device by the external host device.

In example embodiments, the request of the external host device may be a write request including the write data. The first memory controller may be configured to store the write data to the first memory in response to the request of the external host device, and the second memory controller may be configured to store metadata to the second memory, the metadata based on the request of the external host device, in the second memory.

In example embodiments, the request of the external host device may include a key and write data corresponding to the key. The first memory controller may be configured to store the write data in the first memory in response to the request of the external host device, and the second memory controller may be configured to store metadata generated from the key in the second memory in response to the request of the external host device.

In example embodiments, the storage device may further include a hashing circuit configured to perform a hash operation based on the key. The second memory controller may be configured to store an output of the hash circuit in the second memory.

In example embodiments, the first memory controller may be configured to write the write data into a storage space indicated by the metadata in the storage space of the first memory.

In example embodiments, the request of the external host device may include a key. The second memory controller may be configured to read the metadata corresponding to the key from the second memory, and the first memory controller may be configured to read the first read data from the first memory from a position indicated by the read metadata.

In example embodiments, a storage space of the first memory may be larger than that of the second memory.

In example embodiments, an access speed when the first memory controller accesses the first memory may be lower than that when the second memory controller accesses the second memory.

In example embodiments, the first memory may be a power-saving memory, and the second memory may be a high-speed memory.

In example embodiments, write and read units of the first memory may be greater than those of the second memory.

In example embodiments, a unit of bits on which a first error correction circuit of the first memory performs error correction at one time may be greater than that of bits on which a second error correction circuit of the second memory performs error correction at one time.

In example embodiments, the first memory may be a first DRAM and the second memory may be a second DRAM.

In example embodiments, the first DRAM may include a plurality of DRAM chips.

In example embodiments, the first DRAM, first memory controller, second DRAM, and second memory controller are configured such that the first DRAM has a larger storage capacity and a faster access time than the second DRAM.

In example embodiments, a storage device includes a first memory and first memory controller, configured to perform memory accesses at a first speed; and a second memory and second memory controller, configured to perform memory accesses at a second speed faster than the first speed. The first memory controller and second memory controller may be part of a memory controller configured to receive requests from a host external to the storage device. In addition, the memory controller may be configured to, as a result of receiving a request including write data, store the write data in the first memory and store metadata about the write data in the second memory.

The first memory and the second memory may both be volatile memories or may both be non-volatile memories. For example, in one embodiment, both the first memory and the second memory are DRAMs.

In certain embodiments, the first memory includes at least a first semiconductor chip, and the second memory includes at least a second memory chip.

In certain embodiments, the request includes at least a key and a write request. In addition, the memory controller may be further configured to: receive the key and the write request, including the write data; perform a hashing operation on the key to generate metadata; write the write data to the first memory of the storage device based on the metadata; and write the metadata to the second memory of the storage device.

The memory controller may be further configured to: receive the key and a read request; read the metadata corresponding to the key from the second memory of the storage device; read the write data corresponding to the metadata from the first memory of the storage device based on the read metadata; and output the read data.

According to certain embodiments, an operating method of a storage device including heterogeneous first and second dynamic random access memories (DRAMs) according to an embodiment of the inventive concept may include: receiving a key and a write request, including data, at a memory controller of the storage device, performing a hashing operation on the key in the memory controller to generate metadata about the data, writing the data into the first DRAM of the storage device based on the metadata, and writing the metadata into the second DRAM of the storage device.

In example embodiments, the operating method may further include receiving the key and a read request at a memory controller of the storage device, reading the metadata corresponding to the key from the second DRAM of the storage device, reading the data from the first DRAM of the storage device based on the read metadata, and outputting the read data from the storage device.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain principles of the disclosure. In the drawings:

FIG. 1 is a block diagram of a storage device according to certain embodiments of the inventive concept;

FIG. 2 is a table showing a difference between a first type and a second type, according to certain exemplary embodiments;

FIG. 3 is a block diagram illustrating an example of a memory controller in FIG. 1, according to certain exemplary embodiments;

FIG. 4 is a flowchart summarizing an example of an operating method of a storage device according to certain embodiments of the inventive concept;

FIG. 5 is a flowchart summarizing another example of an operating method of a storage device according to certain embodiments of the inventive concept;

FIG. 6 is a block diagram of a storage device according to certain embodiments of the inventive concept;

FIG. 7 is a block diagram of a memory controller according to certain embodiments of the inventive concept;

FIG. 8 is a block diagram of a storage device according to certain embodiments of the inventive concept;

FIG. 9 is a block diagram of a memory controller according to certain embodiments of the inventive concept;

FIG. 10 is a block diagram of a storage device according to certain embodiments of the inventive concept;

FIG. 11 is a block diagram of a memory controller according to certain embodiments of the inventive concept;

FIG. 12 is a block diagram of a storage device according to certain embodiments of the inventive concept; and

FIG. 13 is a block diagram of a memory controller according to certain embodiments of the inventive concept.

### DETAILED DESCRIPTION

Various exemplary embodiments will be described more fully hereinafter with reference to the accompanying drawings, in which some exemplary embodiments are shown. The present invention may, however, be embodied in many different forms and should not be construed as limited to the example embodiments set forth herein. These example embodiments are just that—examples—and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention. In the drawings, the sizes and relative sizes of layers and regions may be exaggerated for clarity. Like numerals refer to like elements throughout.

It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present disclosure. In addition, in certain cases, even if a term is not described using “first,” “second,” etc., in the specification, it may still be referred to as “first” or “second” in a claim in order to distinguish different claimed elements from each other.

As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

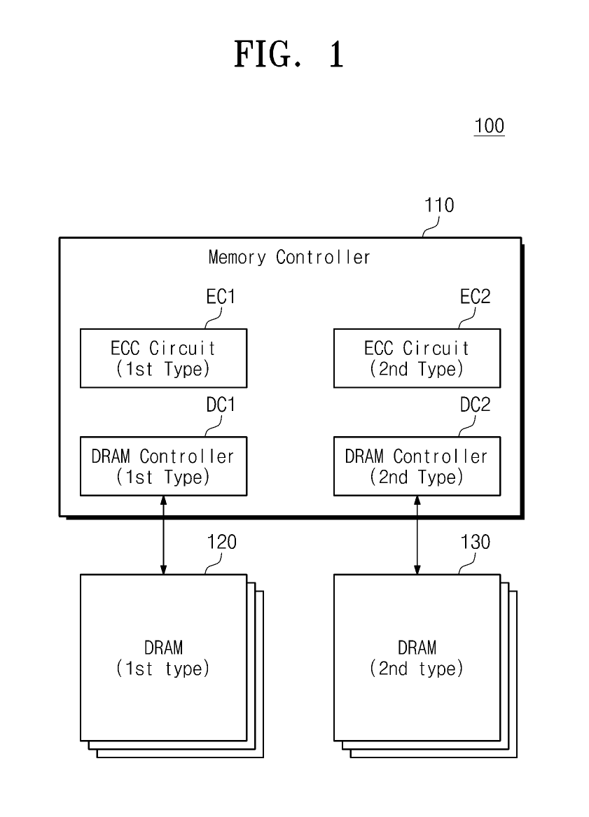

FIG. 1 is a block diagram of a storage device 100 according to certain embodiments of the inventive concept. As illustrated, the storage device 100 includes a memory controller 110, a first memory, such as a first dynamic random access memory (DRAM) 120, and a second memory, such as a second DRAM 130.

The memory controller 110 is configured to control the first DRAM 120 and the second DRAM 130. The first DRAM 120 is of a first configuration type, and the second DRAM 130 is of a second configuration type different from the first type. The memory controller 110 may be configured to drive the heterogeneous first and second DRAMs 120 and 130. In the present disclosure, unless otherwise specified, reference to a memory's type is a reference to a memory's configuration type (i.e. a set of configuration parameters such as capacity, power consumption, ECC strength, etc.) and thus not a reference to the different class-types of memory (e.g. DRAM, SRAM, MRAM, NVRAM, etc.). It should be noted, therefore, that two memories having different configuration types can be memories of the same class-type or of different class-types.

The memory controller 110 includes a first memory controller, such as DRAM controller DC1, a second memory controller, such as DRAM controller DC2, a first error correction circuit EC1, and a second error correction circuit EC2.

The first DRAM controller DC1 is configured to access the first DRAM 120 of the first type and may function according to parameters of the first type. The first error correction circuit EC1 is configured to correct an error of read data read from the first DRAM 120 and may function according to parameters of the first type. For example, the first error correction circuit EC1 may generate error correction data based on write data written into the first DRAM 120 during a write operation on the first DRAM 120, the error correction data being written into the first DRAM 120 with the write data. The read data and the error correction data may be read from the first DRAM 120 during a read operation on the first DRAM 120. The first error correction circuit EC1 may correct data read from the first DRAM 120 using the error correction data read from the first DRAM 120.

The second DRAM controller DC2 is configured to access the second DRAM 130 of the second type and may function according to parameters of the second type. The second error correction circuit EC2 is configured to correct an error of read data read from the second DRAM 130 and may function according to parameters of the second type. For example, the second error correction circuit EC2 may generate error correction data based on write data written into the second DRAM 130 during a write operation on the second DRAM 130, the error correction data being written into the second DRAM 130 with the write data. The read data and the error correction data may be read from the second DRAM 130 during a read operation on the second DRAM 130. The second error correction circuit EC2 may correct an error of data read from the second DRAM 130 using the error correction data read from the second DRAM 130.

The first DRAM controller DC1 and the second DRAM controller DC2 may independently control the first DRAM 120 and the second DRAM 130, respectively. The first and second DRAM controllers DC1 and DC2 (and ECC Circuits EC1 and EC2) may operate independently but may operate on related data in response to a request from an external host device. For example, in response to a single write or read request, the first DRAM controller DC1 may store/read user-data into/from the first DRAM 120, and the second controller DC2 may store/read metadata related to the user-data into/from the second DRAM 130. Also, though the controllers DC1 and DC2 are each described separately from respective ECC Circuits EC1 and EC2, the ECC circuits may each be considered to be part of the respective controllers DC1 and DC2.

In example embodiments, the first type may be specialized in high-capacity data (e.g. a large amount of data but not necessarily high speed). For example, the first memory, such as a first DRAM 120 may be specialized in storing high-capacity data. The first DRAM controller DC1 may be specialized in writing high-capacity data into the first DRAM 120 and reading the high-capacity data from the first DRAM 120. The first error correction circuit EC1 may be specialized in correcting an error of the high-capacity data.

In example embodiments, the second type may be specialized in low-capacity data (e.g. a small amount of data but high speed). For example, the second memory, such as second DRAM 130 may be specialized in storing low-capacity data. The second DRAM controller DC2 may be specialized in writing the low-capacity data into the second DRAM 130 and reading the low-capacity data from the second DRAM 130. The second error correction circuit EC2 may be specialized in correcting an error of the low-capacity data.

In example embodiments, the memory controller 110 may write write-requested data into the first DRAM 120 from an external host device. The memory controller 110 may generate metadata (e.g. data about the write-requested data) from the write-requested data and write the metadata into the second DRAM 130. For example, a storage space of the first DRAM 120 may be identified to be a storage space of the storage device 100 by the external host device, but a storage space of the second DRAM 130 may not be so identified by the external host device. For example, an external host device may send a write request including a write command and write-requested data to memory controller without any designation of which memory (120 or 130) should be used, and without any reference to metadata. In certain embodiments, memory controller 110 receives the write command and write-requested data, and generates the metadata, and then stores the write-requested data in one memory (e.g., DRAM 120) and stores the metadata about he write-requested data in another memory (e.g., DRAM 130).

In example embodiments, the first DRAM 120 may include a plurality of DRAM chips. The DRAM chips of the first DRAM 120 may be of the same type as the first DRAM 120. The DRAM chips of the first DRAM 120 may constitute a single DRAM package or a plurality of DRAM packages. More generally speaking, the first memory, which may in one embodiment be a DRAM class-type memory, may include a semiconductor device including a plurality of semiconductor chips (e.g., DRAM chips). The chips may be packaged in a single package or in a plurality of packages (e.g., in a package-on-package configuration). The chips formed into the first DRAM 120 may have a specific configuration type (e.g., a specific set of operational, and/or physical parameters, such as access speed, memory capacity, etc.).

The second DRAM 130 may include a plurality of DRAM chips. The DRAM chips of the second DRAM 130 may be of the same type as the second DRAM 130. The DRAM chips of the second DRAM 130 may constitute a single DRAM package or a plurality of DRAM packages. More generally speaking, the second memory, which may in one embodiment be a DRAM class-type memory, may include a semiconductor device including a plurality of semiconductor chips (e.g., DRAM chips). The chips may be packaged in a single package or in a plurality of packages (e.g., in a package-on-package configuration). The chips formed into the second DRAM 130 may have a specific configuration type (e.g., a specific set of operational, and/or physical parameters, such as access speed, memory capacity, etc.). The configuration type may be different from the configuration type of the chips of the first DRAM 120, even if the first DRAM 120 and second DRAM 130 have the same class-type.

In certain embodiments, the memory controller 110 may be made of a single semiconductor chip. The memory controller 110 may constitute a single semiconductor package. In certain embodiments, the memory controller 110 may be incorporated into a single semiconductor package together with at least one of the DRAM chips of the first DRAM 120 and/or at least one of the DRAM chips of the second DRAM 130.

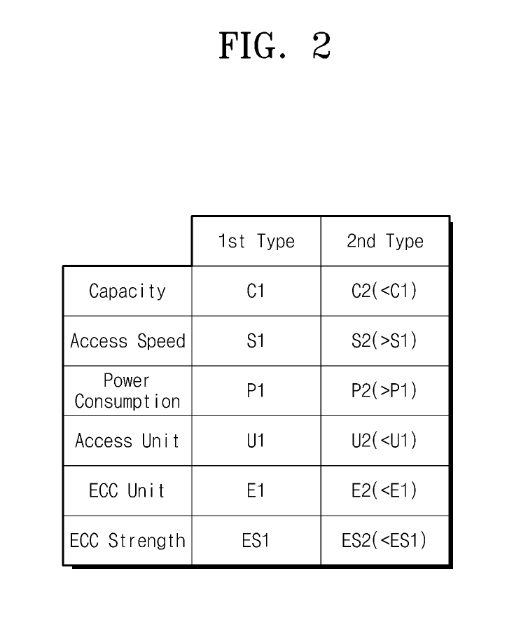

FIG. 2 is a table showing exemplary differences between the first type and the second type where each row includes a different configuration parameter. FIG. 2 merely shows one example, and is not intended to be limiting on the different types that could be used as the first and second memories. Referring to FIGS. 1 and 2, capacity is a first configuration parameter of the first and second types. The first configuration parameter, capacity, of the second DRAM 130 of the second type has a value C2, which is smaller than a capacity C1 of the first DRAM 120 of the first type. The second configuration parameter is access speed. An access speed S2 of the second DRAM 130 and the second DRAM controller DC2 of the second type is higher than access speed S1 of the first DRAM 120 and the first DRAM controller DC1 of the first type.

A third configuration parameter that may set apart the first and second types is power consumption. Power consumption P2 of the second DRAM 130 of the second type may be greater than power consumption P1 of the first DRAM 120 of the first type. A fourth configuration parameter that may set apart the first and second types is the size of a data access unit. An access unit U2 of the second DRAM 130 and the second DRAM controller DC2 of the second type may be, for example, smaller than an access unit U1 of the first DRAM 120 and the first DRAM controller DC1 of the first type. The access unit U2 refers to a unit in which the second DRAM controller DC2 performs read and write operations on the second DRAM 130 in one access, and the access unit U1 refers to a unit in which the first DRAM controller DC1 performs read and write operations on the first DRAM 120 in one access.

Fifth and sixth configuration parameters that may set apart the first and second types are the size of the ECC and the corresponding strength of the ECC. An error correction unit E2 of the second error correction circuit EC2 of the second type may be smaller than an error correction unit E1 of the first error correction circuit EC1 of the first type. The error correction unit E2 may be a source data unit in which the second error correction circuit EC2 performs an error correction operation, and the error correction unit El refers to a data source unit in which the first error correction circuit EC1 performs an error correction operation. Error correction strength ES2 of the second error correction circuit EC2 of the second type may be less than error correction strength ES1 of the first error correction circuit EC1 of the first type. The error correction strength ES2 refers to the maximum number of bit errors that may be corrected when the second error correction circuit EC2 performs error correction, and the error correction strength ES1 is the maximum number of bit errors that may be corrected when the first error correction circuit EC1 performs error correction.

The differing first and second types may be due to differing hardware or control configurations. For example, the capacity differences between the first and second types may be due to differing bus widths. The access speed differences may be due to different feature sizes of the underlying transistors, dopants, and other factors (e.g. channel width, parasitic capacitance, metals, oxides, etc.). The value of the ECC Unit configuration parameter may be, for example, a size measured in terms of bits, and the strength of the ECC may be due to differing algorithms used in the error correction. A type, for example a first or second type, is a representation of multiple configuration parameters. For any type (e.g. the second type) all of the configuration parameters may be different than another type (e.g. the first type); for example, the capacity C2 less than the capacity C1. But not all configuration parameters need to be different and thus just some of the configuration parameters may be different between two types when compared to one another. In certain instances, other configuration parameters may be equal.

In certain embodiments, the first memory (e.g., DRAM 120) and first memory controller (e.g., DRAM controller DC1, which may include ECC Circuit EC1) are configured so that the first memory operates according to a first configuration type, for example based on the various factors discussed above. Further, the second memory (e.g., DRAM 130) and second memory controller (e.g., DRAM controller DC2, which may include ECC Circuit EC2) are configured so that the second memory operates according to a second configuration type different from the first configuration type. As a result of one or more of these configuration types, in certain embodiments, one of the memories (e.g., 130) may permit faster memory accesses than the other (e.g., 120). For example, according to certain embodiments, a storage device includes a first-type dynamic random access memory (DRAM) and a second-type DRAM. High-capacity user data is stored in the first-type DRAM, and low-capacity metadata is stored in the second-type DRAM. Thus, operating speed and reliability of the storage device may be improved.

In example embodiments, the error correction circuit EC1 of the first type may perform error correction using a Bose-Chaudhuri-Hocquenghem (BCH) code that is capable of correcting a multi-bit error. The error correction circuit EC2 of the second type may perform error correction using a low-latency Hamming code.

The first DRAM 120 may have relatively high capacity and low power consumption and operating speed. Since an access unit of the first DRAM 120 is relatively large, the error correction unit and the error correction strength of the first error correction circuit EC1 are relatively large and high, respectively. The second DRAM 130 may have relatively low capacity and high power consumption and operating speed. Since an access unit of the second DRAM 130 is relatively small, the error correction unit and the error correction strength of the second error correction circuit EC2 are relatively small and low, respectively.

The more the maximum number of bit errors correctable by the first error correction circuit EC1 increases, the more a refresh period of the first DRAM 120 may increase. For example, a refresh period of the first DRAM 120 may increase until the number of bit errors that may occur in the first DRAM 120 reaches a maximum critical ratio (e.g., 25 percent, 50 percent, etc.) The maximum critical ratio may be ratio between the critical number of bit errors which causes the refresh and the maximum number of bit errors. For example, the maximum critical ratio may be 25 percentage or 50 percentage of the maximum number of bit errors. Thus, the power consumption of the first DRAM 120 may be further reduced due to a decrease in a refresh frequency.

In one embodiment, a first memory, such as the first DRAM 120 is configured to store high-capacity user data according to a request of an external host device. The second memory, such as the second DRAM 130 is configured to store low-capacity metadata about the high-capacity user data. In certain embodiments, the low-capacity metadata may be generated from high-capacity user data. In one embodiment, when the heterogeneous first and second DRAMs 120 and 130 are provided, data may be stored in an optimal one of the first and second DRAMs 120 and 130 depending on characteristics of the data, e.g., depending on whether the data is the user data or the metadata. For example, user data may be stored in the slower, higher capacity memory, and the metadata may be stored in the faster, lower capacity memory.

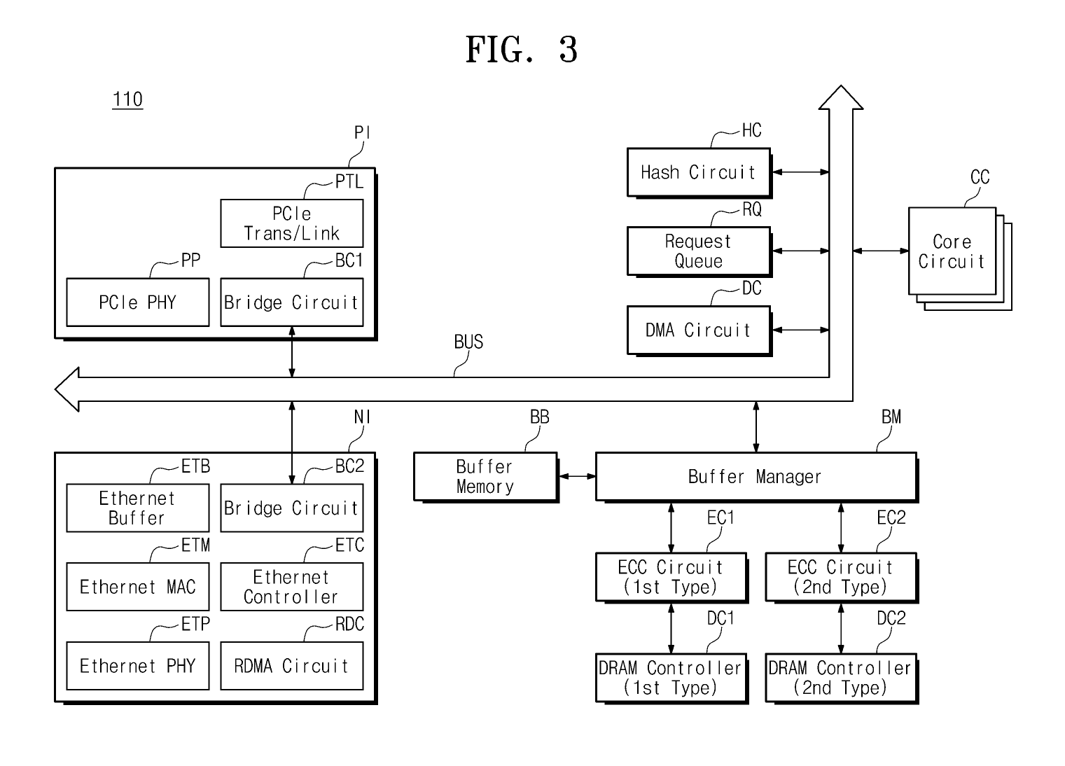

FIG. 3 is a block diagram illustrating an example of the memory controller 110 in FIG. 1, according to certain exemplary embodiments. As illustrated, the memory controller 110 includes a bus BUS, a peripheral component interconnect express (PCIe) interface PI, a network interface NI, a hash circuit HC, a request queue RQ, a direct memory access (DMA) circuit DC, a core circuit CC, a buffer manager BM, a buffer memory BB, a first error correction circuit EC1, a second error correction circuit EC2, a first DRAM controller DC1, and a second DRAM controller DC2.

The bus BUS is configured to provide a channel between components of the memory controller 110.

The PCIe interface PI is configured to communicate with an external host device, for example, according to a PCIe standard. The PCIe interface PI may transmit a request received from the external host device to the bus BUS. The PCIe interface PI may output a message received through the bus BUS to the external host device. The PCIe interface PI includes a first bridge circuit BC1, a PCIe transport/link (PTL), and a PCIe PHY (PP).

The first bridge circuit BC1 may be configured to support intermediate communication between the PCIe transport/link (PTL) and the bus BUS and between the PCIe PHY (PP) and the bus BUS.

The PCIe transport/link (PTL) indicates a transport layer and a link layer defined by the PCIe standard. The PCIe transport/link (PTL) may be implemented with hardware (e.g. a VLSI circuit implemented in an ASIC or FPGA) to support a transport layer and a link layer of the PCIe standard and/or software to support a transport layer and a link layer of the PCIe standard.

The PCIe PHY (PP) indicates a physical layer defined by the PCIe standard. The PCIe PHY (PP) may be implemented with hardware to exchange various signals with an external host device and/or hardware driving software to support a PHY layer of the PCIe standard.

In FIG. 3, it is explained that the memory controller 110 communicates with the external host device through the PCIe interface PI. However, types of interface for communication between the memory controller 110 and the external host device are not limited to the PCIe interface.

The network interface NI is configured to communicate with an external network according to a network standard, e.g., the Ethernet standard, which may be wired or wireless. The network interface NI may transmit a request received through the external network to the bus BUS. The network interface NI may output a message received from the bus BUS to the external network. The network interface NI includes a second bridge circuit BC2, an Ethernet controller ETC, a remote DMA (RDMA) circuit RDC, an Ethernet buffer ETB, an Ethernet MAC (ETM), and an Ethernet PHY (ETP).

The second bridge circuit BC2 is configured to support intermediate communications between the Ethernet controller ETC and the bus BUS, between the RDMA circuit RDC and the bus BUS, between the Ethernet buffer ETB and the bus BUS, between the Ethernet MAC (ETM) and the bus BUS, and between the Ethernet PHY (ETP) and the bus BUS.

The Ethernet controller ETC may control the overall operation where the network interface NI communicates with the external network and communicates with the bus BUS through the second bridge circuit BC2. The Ethernet buffer ETB may function as a buffer memory of the network interface NI. The RDMA circuit RDC is configured to exchange data with the external network. The Ethernet MAC (ETM) may be configured to hardware to support a MAC layer according to an Ethernet standard or software to support an Ethernet MAC layer. The Ethernet PHY (ETP) may be implemented with hardware to exchange various signals with the external network and/or hardware driving software to support a PHY layer of the Ethernet standard.

In FIG. 3, it is explained that the memory controller 110 communicates with the external network based on the Ethernet standard. However, the network interface NI is not limited to an Ethernet-based network interface.

The request queue RQ is configured to store a request, e.g., a read request or a write request of data received through the PCIe interface PI or the network interface NI.

The hash circuit HC is configured to perform a hashing operation on data received through the PCIe interface PI and the network interface NI. For example, the hash circuit HC may calculate a hash from all or some of respective requests stored in the request queue RQ. The hash circuit HC may be hardware configured to perform a hashing operation. The hash circuit HC may be hardware configured to drive software (e.g. running on a co-processor such as on the core circuit CC) to perform a hashing operation.

The DMA circuit DC may exchange data with an external host device or an external network through the PCIe interface PI and/or the network interface NI. The DMA circuit DC may read data from the first DRAM 120 or the second DRAM 130 and output the read data to the PCIe interface PI and/or the network interface NI. The DMA circuit DC may forward data from the PCIe interface PI and the network interface NI to the first DRAM 120 and the second DRAM 130.

The core circuit CC may control the overall operation of the memory controller 110. The core circuit CC may access the first DRAM 120 and the second DRAM 130 in response to a request stored in the request queue RQ. The core circuit CC may include a plurality of cores.

The buffer manager BM may manage intermediate communications between the bus BUS and the buffer memory BB, between the bus BUS and the first error correction circuit EC1, and between the bus BUS and the second error circuit EC2.

The buffer memory BB may be configured to temporarily store data written into the first DRAM 120 or data read from the first DRAM 120. The buffer memory BB may be configured to temporarily store data written into the second DRAM 130 or data read from the second DRAM 130. The buffer memory BB may be configured to temporarily store various types of information managed by the core circuit CC. The buffer memory BB may include, for example, a static RAM (SRAM).

The first error correction circuit EC1 and the second error correction circuit EC2 may each communicate with the buffer manager BM. The first DRAM controller DC1 and the second DRAM controller DC2 may communicate with the first error correction circuit EC1 and the second error correction circuit EC2, respectively, and control the first DRAM 120 and the second DRAM 130, respectively.

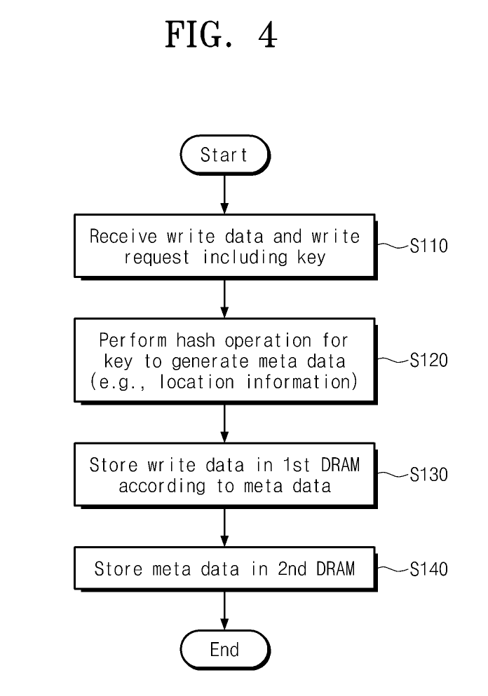

FIG. 4 is a flowchart summarizing an example of an operating method of the storage device 100 according to an embodiment of the inventive concept. An exemplary writing method of the storage device 100 is illustrated in FIG. 4. Referring to FIGS. 1, 3, and 4, the storage device 100 receives write data and a write request including a key (S110). The write request including the key may be stored in the request queue RQ. The write data may be stored in the buffer memory BB.

A hashing operation is performed on the key included in the write request to generate metadata (S120). For example, the metadata may include position information of a storage space of the first DRAM 120 into which the write data is to be written.

The write data is stored in the first DRAM 120 according to the metadata (S130). For example, the write data may be written into a storage space corresponding to position information indicated by the metadata in the storage space of the first DRAM 120. For example, the write data may be written into the first DRAM 120 according to the control of the first DRAM controller DC1.

The metadata is written into the second DRAM 130 (S140). For example, the core circuit CC may generate a table that interconnects the key included in the write request with the metadata generated from the key and may store the generated table in the second DRAM 130. The core circuit CC may further generate an index to support search of the table and may store the generated index in the second DRAM 130. The metadata, the table, and the index may be stored in the second DRAM 130 according to the control of the second DRAM controller DC2.

The storage device 100 may manage data based on key-value store. The key included in the write request may correspond to a key of the key-value store, and the write data may correspond to a value of the key-value store. The storage device 100 may perform a hashing operation on the key included in the write request to generate metadata. The write data may be stored in a position indicated by the metadata in the storage space of the first DRAM 120. The storage device 100 may store the metadata generated from the key in the second DRAM 130.

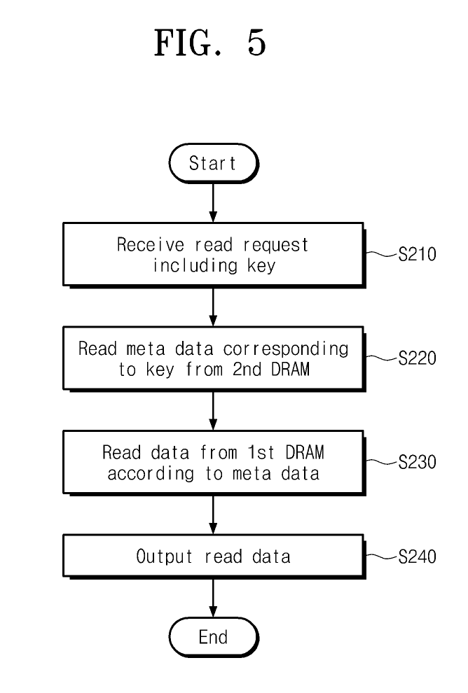

FIG. 5 is a flowchart summarizing another example of an operating method of the storage device 100 according to an embodiment of the inventive concept. A reading method of the storage device 100 is illustrated in FIG. 5. Referring to FIGS. 1, 3, and 5, the storage device 100 receives a read request including a key. The read request including the key may be stored in the request queue RQ (S210).

The storage device 100 may read metadata corresponding to the key from the second DRAM 130 (S220). For example, the core circuit CC may detect metadata associated with the key using the table stored in the second DRAM 130. The core circuit CC may detect metadata associated with the key from the table with reference to the index stored in the second DRAM 130. The metadata may be read from the second DRAM 130 according to the control of the second DRAM controller DC2.

The storage device 100 may read data from the first DRAM 120 according to the metadata read from the second DRAM 130 (S230). Data may be read from the first DRAM 120 according to the control of the first DRAM controller DC1.

The storage device 100 may output the read data (S240).

The storage device 100 may manage data based on key-value store. The key included in the read request may correspond to a key of the key-value store, and the data read from the first DRAM 120 may correspond to a value of the key-value store. The storage device 100 may read metadata corresponding to the key included in the read request from the second DRAM 130, instead of performing a hashing operation on the key included in the read request to generate metadata. The read data may be read from a position indicated by the metadata in the storage space of the first DRAM 120.

As described with reference to FIGS. 4 and 5, the storage device 100 may be configured to operate based on a key-value store. During a write operation, the storage device 100 may store write data in the first DRAM 120 and metadata generated from a key in the second DRAM 130. During a read operation, the storage device 100 may read metadata corresponding to the key from the second DRAM 130 and read data from the first DRAM 120 based on the metadata. Since the metadata generated during the write operation is stored in the second DRAM 130, an operation of storing the metadata is omitted during the read operation. Thus, operation performance of the storage device 100 is improved.

The first DRAM 120 may be specialized for the first type to store high-capacity data, and the second DRAM 130 may be specialized for the second type to store low-capacity metadata. As the first DRAM 120 and the second DRAM 130 are specialized for the first type and the second type, respectively, the operation performance of the storage device 100 may be further improved (e.g. improved in terms of access speed, power consumption, and ECC performance).

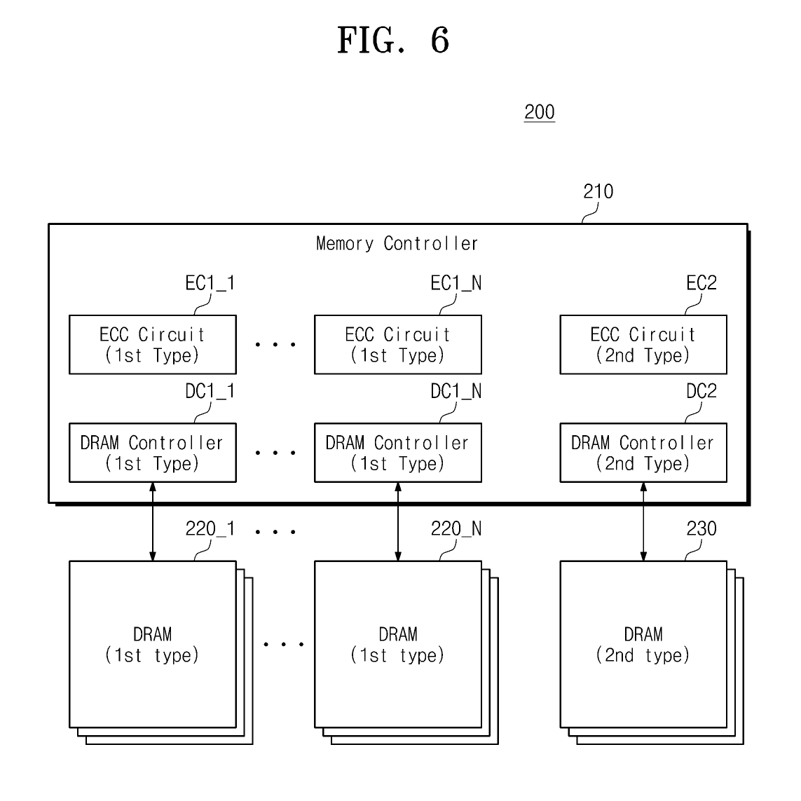

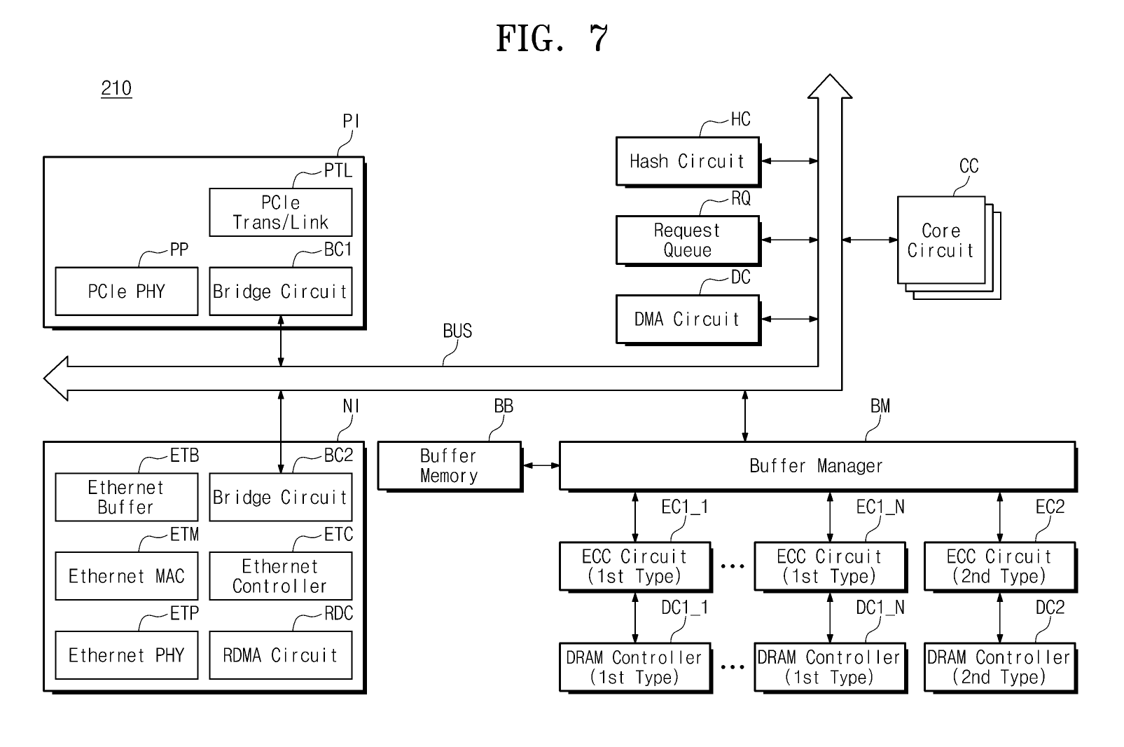

FIG. 6 is a block diagram of a storage device 200 according to another embodiment of the inventive concept, and FIG. 7 is a block diagram of a memory controller 210 according to another embodiment of the inventive concept. The storage device 200 includes a plurality of first memories, such as first DRAMs 220_1 to 220_N, of a first type, a plurality of first memory controllers, such as DRAM controllers DC1_1 to DC1_N, of the first type, a plurality of first error correction circuits EC1_1 to EC1_N of the first type, a second memory, such as DRAM 230, of a second type, a second memory controller, such as DRAM controller DC2, of the second type, and a second error correction circuit EC2 of the second type.

As compared to the storage device 100 and the memory controller 110 in FIGS. 1 and 3, the storage device 200 includes the plurality of first memories, such as first DRAMs 220_1 to 220_N, the plurality of first memory controllers, such as DRAM controllers DC1_1 to DC1_N, and the plurality of error correction circuits EC1_1 to EC1_N. The first DRAM controllers DC1_1 to DC1_N may independently control the first DRAMs 220_1 to 220_N, respectively. The first error correction circuits EC1_1 to EC1_N may independently correct errors of data read from the first DRAMs 220_1 to 220_N, respectively.

The storage device 200 may store data in the first DRAMs 220_1 to 220_N. The storage device 200 may store metadata about the stored data, for example, generated from data written into the first DRAMs 220_1 to 220_n, in the second DRAM 230. For example, the storage device 200 may store metadata, generated from a key associated with data written into the first DRAMs 220_1 to 220_n, in the second DRAM 230.

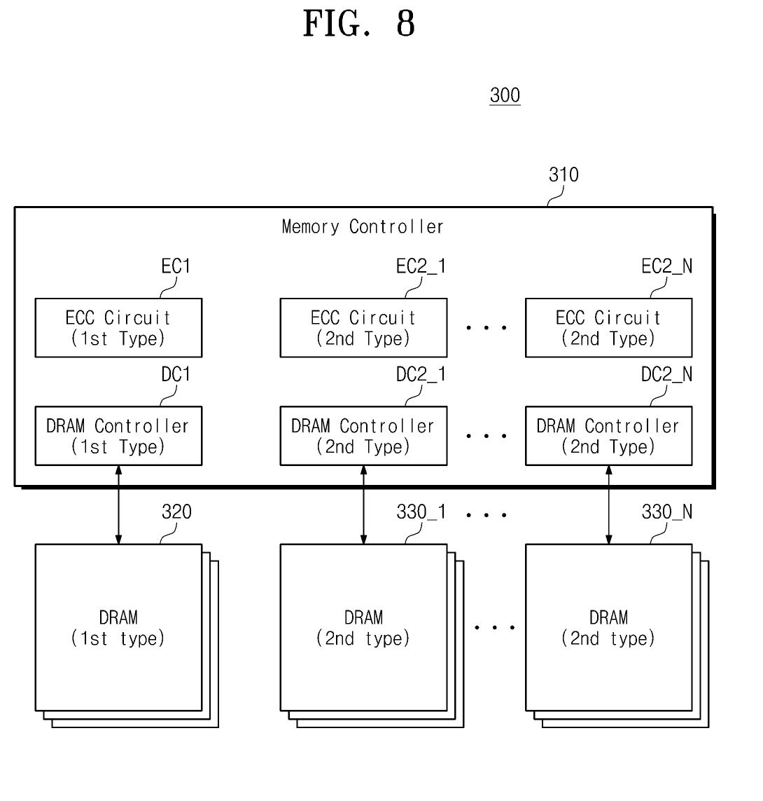

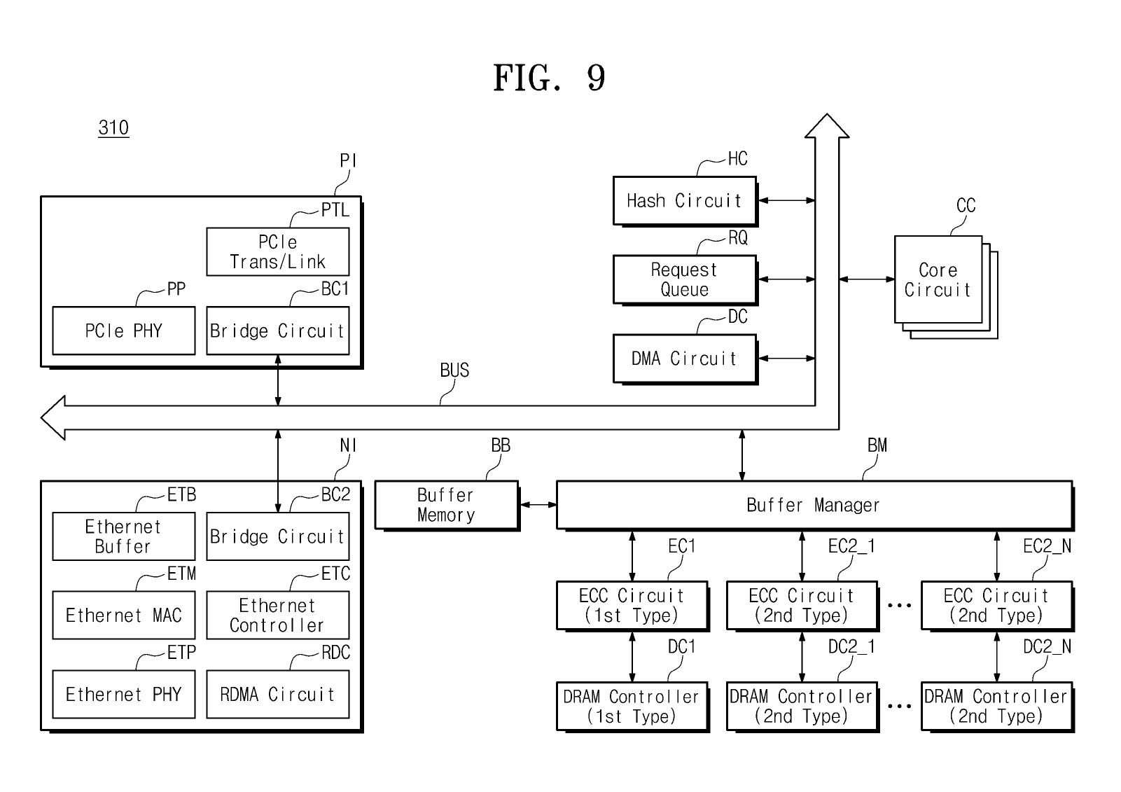

FIG. 8 is a block diagram of a storage device 300 according to another embodiment of the inventive concept, and FIG. 9 is a block diagram of a memory controller 310 according to another embodiment of the inventive concept. The storage device 300 includes a first memory, such as first DRAM 320, of a first type, a first memory controller, such as DRAM controller DC_1, of the first type, a first error correction circuit EC1 of the first type, a plurality of second memories, such as DRAMs 330_1 to 330_N, of a second type, a plurality of second memory controllers, such as DRAM controllers DC2_1 to DC2_N, of the second type, and a plurality of second error correction circuits EC2_1 to EC2_N of the second type.

As compared to the storage device 100 and the memory controller 110 in FIGS. 1 and 3, the storage device 300 includes the plurality of second DRAMs 330_1 to 330_N, the plurality of second DRAM controllers DC2_1 to DC2_N, and the plurality of second error correction circuits EC2_1 to EC2_N. The second DRAM controllers DC2_1 to DC2_N may independently control the second DRAMs 330_1 to 330_N, respectively. The second error correction circuits EC2_1 to EC2_N may independently correct errors of data read from the second DRAMs 330_1 to 330_N, respectively.

The storage device 300 may store data in the first DRAM 320. The storage device 300 may store metadata about the stored data, and which may be generated from data written into the first DRAM 320, in the second DRAMs 330_1 to 330_N. For example, the storage device 300 may store metadata generated from a key associated with data written into the first DRAM 320 in the second DRAMs 330_1 to 330_N.

As described with reference to FIGS. 6 and 7, the storage device 300 may be changed and applied to include a plurality of first DRAMs, a plurality of first DRAM controllers, and a plurality of first error correction circuits.

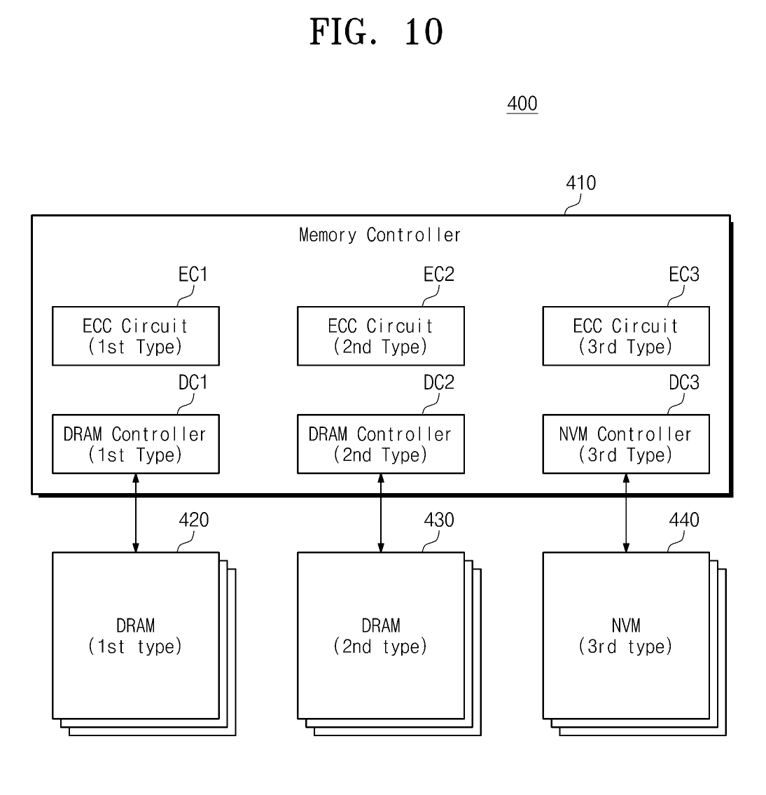

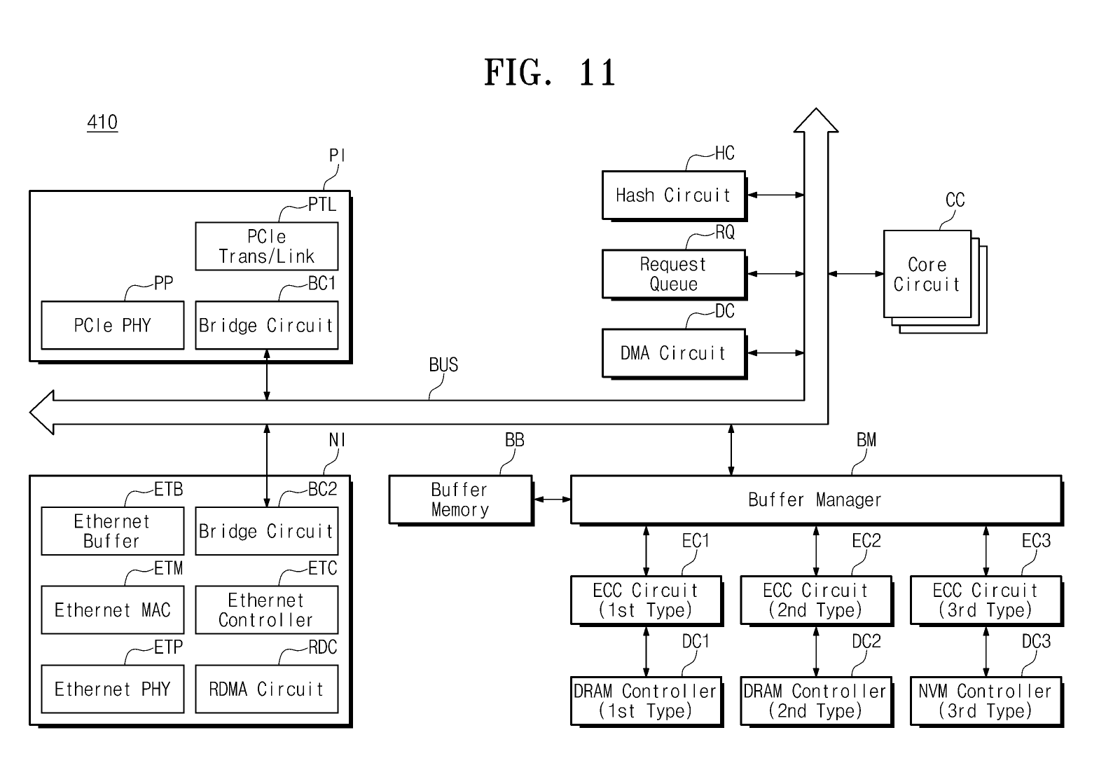

FIG. 10 is a block diagram of a storage device 400 according to another embodiment of the inventive concept, and FIG. 11 is a block diagram of a memory controller 410 according to another embodiment of the inventive concept. The storage device 400 may include a first memory (e.g., volatile memory such as DRAM 420) of a first type, a first memory controller (e.g., DRAM controller DC1) of the first type, a first error correction circuit EC1 of the first type, a second memory (e.g., volatile memory such as DRAM 430) of a second type, a second memory controller (e.g., DRAM controller DC2) of the second type, a second error correction circuit EC2 of the second type, a third memory (e.g., nonvolatile memory (NVM) 440) of a third type, an NVM controller DC3 of the third type, and a third error correction circuit EC3 of the third type. The first and second types may be different, similar to the different memory types described in connection with FIG. 1.

As compared to the storage device 100 and the memory controller 110 in FIGS. 1 and 3, the storage device 400 further includes the third NVM 440, the third NVM controller DC3, and the third error correction circuit EC3.

The third NVM 440 may include at least one of various nonvolatile memories such as a phase-change RAM (PRAM), a magnetic RAM (MRAM), a resistive RAM (RRAM), and a ferroelectric RAM (FeRAM).

The third NVM controller DC3 is configured to access the third NVM 440. The third NVM controller DC3 may control the third NVM 440 independently of the first DRAM controller DC1 and the second DRAM controller DC2.

The third error correction circuit EC3 may be configured to correct data read from the third NVM 440. For example, when write data is written into the third NVM 440, the third error correction circuit EC3 may generate error correction data. The error correction data may be written into the third NVM 440 together with the write data. The data and the error correction data may be read from the third NVM during a read operation. The third error correction circuit EC3 may correct an error of the data read from the third NVM 440 using the error correction data read from the third NVM 440.

In exemplary embodiments, the storage device 400 may back-up data written into the first DRAM 420 and/or the second DRAM 430 to the third NVM 440. For example, the data written into the first DRAM 420 or the second DRAM 430 may be backed up to the third NVM 440.

For example, when data is written into the first DRAM 420 or the second DRAM 430, the data may be written into the third NVM at the same time. When data is written into the first DRAM 420 or the second DRAM 430, the data may be scheduled to be written into the third NVM 440.

As described with reference to FIGS. 6 and 7, the storage device 400 may be changed and applied to include a plurality of first DRAMs, a plurality of first DRAM controllers, and a plurality of first error correction circuits. As described with reference to FIGS. 8 and 9, the storage device 400 may be changed and applied to include a plurality of second DRAMs, a plurality of second DRAM controllers, and a plurality of second error correction circuits. The storage device 400 may also be changed and applied to include a plurality of third NVMs, a plurality of third NVM controllers, and a plurality of third error correction circuits (not shown). In example embodiments, the third NVM may include a plurality of NVM chips.

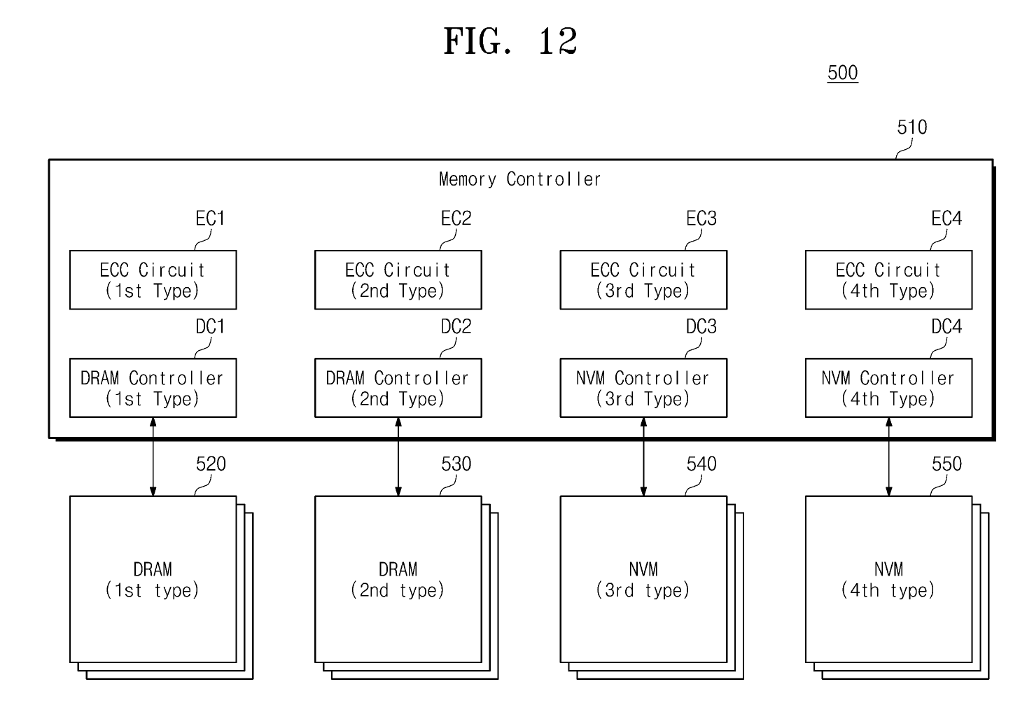

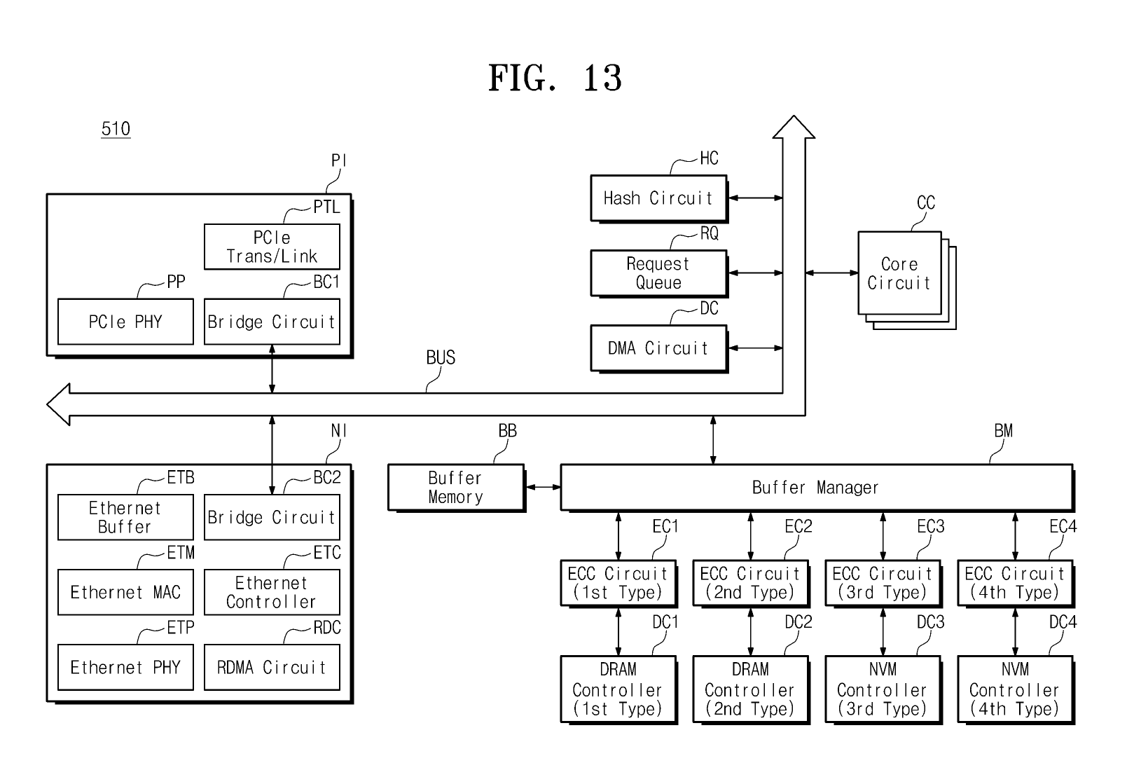

FIG. 12 is a block diagram of a storage device 500 according to another embodiment of the inventive concept, and FIG. 13 is a block diagram of a memory controller 510 according to another embodiment of the inventive concept. The storage device 500 includes a first memory of a first class-type, such as a volatile memory (e.g., DRAM 520) and of a first configuration type, a first memory controller for the first memory (e.g., DRAM controller DC1) having parameters of the first type, a first error correction circuit EC1 having parameters of the first type, a second memory of the first class-type, such as the volatile memory (e.g., second DRAM 530) of a second configuration type, a second memory controller for the second memory (e.g., DRAM controller DC2) of the second configuration type, a second error correction circuit EC2 of the second configuration type, a third memory of a second class-type (e.g., nonvolatile memory (NVM)) of a third configuration type, an NVM controller DC3 of the third configuration type, a third error correction circuit EC3 of the third configuration type, a fourth memory of the second class-type (e.g., nonvolatile memory NVM 550) of a fourth configuration type, a fourth NVM controller DC4 of the fourth configuration type, and a fourth error correction circuit EC4 of the fourth configuration type.

As compared to the storage device 100 and the memory controller 110 in FIGS. 1 and 3, the storage device 500 further includes the third NVM 540, the third NVM controller DC3, the third error correction circuit EC3, the fourth NVM 550 of the fourth type, the fourth NVM controller DC4 of the fourth type, and the fourth error correction circuit EC4 of the fourth type.

The third NVM 540 may include at least one of various nonvolatile memories such as a phase-change RAM (PRAM), a magnetic RAM (MRAM), a resistive RAM (RRAM), and a ferroelectric RAM (FeRAM).

The third NVM controller DC3 is configured to access the third NVM 540. The fourth NVM controller DC4 is configured to access the fourth NVM 550.

The third error correction circuit EC3 may be configured to correct an error of data read from the third NVM 540. The fourth error correction circuit EC4 may be configured to correct an error of data read from the fourth NVM 550.

In example embodiments, the storage device 500 may back-up data written into the first DRAM 520 and the second DRAM 530 to the third NVM 540 and the fourth NVM 550, respectively. For example, data written into the first DRAM 520 may be backed up to the third NVM 540 or may be scheduled to be backed up to the third NVM 540. Data written into the second DRAM 530 may be backed up to the fourth NVM 550 or may be scheduled to be backed up to the fourth NVM 550.

The third type and the fourth type may correspond to the first type and the second type described with reference to FIG. 2, respectively. For example, the third NVM 540 of the third type may be a NAND flash memory, and the fourth NVM 550 of the fourth type may include at least one of a PRAM, an MRAM, an RRAM, an FeRAM, and a NOR flash memory.

As described with reference to FIGS. 6 and 7, the storage device 500 may be changed and applied to include a plurality of first DRAMs, a plurality of DRAM controllers, and a plurality of first error correction circuits. As described with reference to FIGS. 8 and 9, the storage device 500 may be changed and applied to include a plurality of second DRAMs, a plurality of second DRAM controllers, and a plurality of second error correction circuits. The storage device 500 may also be changed and applied to include a plurality of third NVMs, a plurality of third NVM controllers, and a plurality of third error correction circuits (not shown). The storage device 500 may similarly be changed and applied to include a plurality of fourth NVMs, a plurality of fourth NVM controllers, and a plurality of fourth error correction circuits (not shown). In example embodiments, the fourth NVM may include a plurality of NVM chips.

The first and second DRAM controllers DC1 and DC2 (and ECC Circuits EC1 and EC2) may operate independently but may operate together on related data in response to a request from an external host device. For example, in response to a single write or read request, the first DRAM controller DC1 may store/read user-data to/from the first DRAM 520, and the second controller DC2 may store/read metadata to/from the second DRAM 530. Similarly, the third and fourth DRAM controllers DC3 and DC4 (and ECC Circuits EC3 and EC4) may operate independently in response to the request. For example, they may respond to the request together by backing up user-data directed to the first DRAM 520 into the third DRAM 540 while backing up metadata directed to the second DRAM 530 into the fourth DRAM 550.

While specific examples, such as DRAM, have been used to describe various embodiments, the invention is not limited to these examples. For example, a different type of volatile memory can be used in place of the DRAMs described in the various embodiments. Or in some cases, certain types of non-volatile memories may be used in place of the DRAMs described herein.

The memories described herein (e.g., DRAM, NVM, etc.) can be in different physical forms. For example, in some examples, each memory may be a semiconductor device such as a chip or package, or package-on-package device. In other examples, each memory may be a memory module, including for example, a plurality of semiconductor memory chips or semiconductor memory packages on a module board. In yet other embodiments, the first type memories, second type memories, and memory controller can all be part of a single memory package or memory module.

While the present disclosure has been particularly shown and described with reference to exemplary embodiments thereof, the general inventive concept is not limited to the above-described embodiments. It will be understood by those of ordinary skill in the art that various changes and variations in form and details may be made therein without departing from the spirit and scope of the inventive concept as defined by the following claims.

What is claimed is:

1. A storage device comprising:
a first memory;
a second memory; and
a memory controller, including:
a first memory controller configured to access the first memory according to a request of an external host device; and
a second memory controller configured to access the second memory according to the request of the external host device, wherein
the first memory and first memory controller are configured so that the first memory operates according to a first configuration type,
the second memory and second memory controller are configured so that the second memory operates according to a second configuration type different from the first configuration type, and
the memory controller is configured to receive the request from the external host and based on the request, to store write data to the first memory, and store metadata about the write data to the second memory.

2. The storage device as set forth in claim 1, wherein a storage space of the first memory is identified as a storage space of the storage device by the external host device, and
wherein a storage space of the second memory is not identified as the storage space of the storage device by the external host device.

3. The storage device as set forth in claim 1, wherein the request of the external host device is a write request including the write data,
wherein the first memory controller is configured to store the write data in the first memory in response to the request of the external host device, and
wherein the second memory controller is configured to store the metadata in the second memory, the metadata based on the request of the external host device, in the second memory.

4. The storage device as set forth in claim 1, wherein the request of the external host device includes a key and write data corresponding to the key,
wherein the first memory controller is configured to store the write data in the first memory in response to the request of the external host device, and
wherein the second memory controller is configured to store metadata generated from the key in the second memory in response to the request of the external host device.

5. The storage device as set forth in claim 4, further comprising:
a hash circuit configured to perform a hashing operation based on the key,
wherein the second memory controller is configured to store an output of the hash circuit in the second memory.

6. The storage device as set forth in claim 1, wherein the first memory controller is configured to write the write data into a storage space indicated by the metadata in the storage space of the first memory.

7. The storage device as set forth in claim 1, wherein the request of the external host device includes a key,
wherein the second memory controller is configured to read the metadata corresponding to the key from the second memory, and
wherein the first memory controller is configured to read the first read data from the first memory from a position indicated by the read metadata.

8. The storage device as set forth in claim 1, wherein write and read units of the first memory are greater than those of the second memory.

9. The storage device as set forth in claim 1, wherein a unit of bits on which a first error correction circuit of the first memory performs error correction at one time is greater than that of bits on which a second error correction circuit of the second memory performs error correction at one time.

10. The storage device as set forth in claim 1, wherein the first memory is a first DRAM and the second memory is a second DRAM.

11. The storage device as set forth in claim 10, wherein:
the first DRAM, first memory controller, second DRAM, and second memory controller are configured such that the first DRAM has a larger storage capacity and a faster access time than the second DRAM.

12. The storage device as set forth in claim 1, wherein the write data is written into the storage space of the first memory corresponding to position information indicated by the metadata stored in the second memory.

13. A storage device, comprising:
a first memory and first memory controller, configured to perform memory accesses at a first speed; and
a second memory and second memory controller, configured to perform memory accesses at a second speed faster than the first speed, wherein:
the first memory controller and second memory controller are part of a memory controller configured to receive requests from a host external to the storage device; and
the memory controller is configured to, as a result of receiving a request including write data, store the write data in the first memory and store metadata about the write data in the second memory.

14. The storage device of claim 13, wherein the first memory and the second memory are either both volatile memories or are both non-volatile memories.

15. The storage device of claim 14, wherein the first memory and the second memory are both DRAMs.

16. The storage device of claim 14, wherein the first memory includes at least a first semiconductor chip, and the second memory includes at least a second memory chip.

17. The storage device of claim 13, wherein the request includes at least a key and a write request and the memory controller is further configured to:
receive the key and the write request, including the write data;
perform a hashing operation on the key to generate metadata;
write the write data to the first memory of the storage device based on the metadata; and
write the metadata to the second memory of the storage device.

18. The storage device of claim 17, wherein the memory controller is further configured to:
receive the key and a read request;
read the metadata corresponding to the key from the second memory of the storage device;
read the write data corresponding to the metadata from the first memory of the storage device based on the read metadata; and
output the read data.

19. An operating method of a storage device including heterogeneous first and second dynamic random access memories (DRAMs), the operating method comprising:
receiving a key and a write request, including data, at a memory controller of the storage device;
performing a hashing operation on the key in the memory controller to generate metadata about the data;
writing the data into the first DRAM of the storage device based on the metadata; and
writing the metadata into the second DRAM of the storage device.

20. The operating method as set forth in claim 19, further comprising:
receiving the key and a read request at a memory controller of the storage device;
reading the metadata corresponding to the key from the second DRAM of the storage device;
reading the data from the first DRAM of the storage device based on the read metadata; and
outputting the read data from the storage device.
